(19) United States
(12) Patent Application Publication
(10) Pub. No.: US 2025/0301013 A1
(43) Pub. Date: Sep. 25, 2025

(54) METHOD FOR MANAGING CYBERSECURITY THREAT AND ATTACK SURFACE, AND DEVICE FOR PERFORMING SAME

(71) Applicant: IN THE FOREST CO., LTD, Seoul (KR)

(72) Inventors: Sa Woong KIM, Seoul (KR); Dong Min SEO, Bucheon-si (KR)

(21) Appl. No.: 19/233,260

(22) Filed: Jun. 10, 2025

Related U.S. Application Data
(63) Continuation of application No. PCT/KR2023/020378, filed on Dec. 12, 2023.

(30) Foreign Application Priority Data
Dec. 15, 2022 (KR) 10-2022-0175743

(51) Int. Cl. H04L 9/40

(52) U.S. Cl. CPC H04L 63/1433; H04L 63/1425

(57) ABSTRACT

The present invention relates to a method for managing a cybersecurity threat and attack surface, and a device for performing the method. The method for managing a cybersecurity threat and attack surface may comprise: a step in which a cybersecurity management device collects attack surface information and security threat information; and a step in which the cybersecurity management device automatically verifies the validity of the security threat information through automated testing on the basis of the attack surface information and security threat information.

### TECHNICAL FIELD

The present invention relates to a method of managing a cybersecurity threat and an attack surface and an apparatus for performing the method. More specifically, the present invention relates to a method of detecting and diagnosing a threat to exposed security and an apparatus for performing the method that are capable of identifying exposed, disclosed, and leaked security threats through an automated solution and automatically providing diagnostic results therefor.

### BACKGROUND ART

Among the areas in which hacking incidents continue to easily occur, an increasing number of cases involve hacking based on leaked credential account information rather than high-level hacking techniques, indicating the need to continuously monitor and manage information exposed on the dark web.

Recently, the global security solution industry has been providing solutions and services under the term attack surface management (ASM). However, the existing services are not new concepts or new services, and the existing solutions have simply been rebranded as ASM solutions for marketing purposes, and in most cases, the existing security threat information collection/provision solutions (e.g. threat intelligence solution or OSINT solution) have simply been equipped with some functions (e.g. dark web information provision solution) and serviced as ASM services.

Therefore, there is a need for research and development of specific technologies to search for and continuously monitor attack targets, services, IPs, domains, networks, host names, and other artifacts (evidence, traces) to identify an attack surface of an organization from the perspective of external attackers.

The related art includes Korean Laid-Open Patent No. 10-2020-011848.

### SUMMARY

### Technical Problem

The present invention aims to resolve all of the limitations described above.

In addition, the present invention aims to provide a function that makes it possible to collect attack surface information, which is security threat information, and perform automated test results based on the collected information.

In addition, the present invention aims to collect information by dividing various types of security threat information by classifying the information in detail by stages without affecting the target object when collecting information, and to automatically verify the validity of the collected threat information by performing tests on the collected security threat information with an automated function rather than a diagnostician (a human).

### Technical Solution

A representative configuration of the present invention to achieve the above object is as follows.

According to one aspect of the present invention, a method of managing a cybersecurity threat and an attack surface includes: collecting, by a cybersecurity management apparatus, attack surface information and security threat information; and automatically verifying, by the cybersecurity management apparatus, validity of the security threat information by performing an automated test based on the attack surface information and the security threat information.

The attack surface information may include information on assets of a company, which include network equipment, a database (DB), a server, ports, an application, and a domain and are connected to the Internet and exposed to risks, and the security threat information includes information exposed through a web or an application that threatens security of the company.

The cybersecurity management apparatus may collect the security threat information and the attack surface information through open source intelligence (OSINT) including general Open_web and Surface_web, DeepWeb, and Dark Web.

According to another aspect of the present invention, a cybersecurity management device for managing a cybersecurity threat and an attack surface is configured to: collect attack surface information and security threat information; and automatically verify validity of the security threat information by performing an automated test based on the attack surface information and the security threat information.

The attack surface information may include information on assets of a company, which include network equipment, a database (DB), a server, a port, an application, and a domain and are connected to the Internet and exposed to risks, and the security threat information may include information exposed through a web or an application that threatens security of the company.

The cybersecurity management apparatus may collect the security threat information and the attack surface information through open source intelligence (OSINT) including general Open_web and Surface_web, DeepWeb, and DarkWeb.

### Advantageous Effects

According to the present invention, it is possible to provide a function that makes it possible to collect attack surface information, which is security threat information, and perform automated test results based on the collected information.

In addition, according to the present invention, it is possible to collect information by dividing various types of security threat information by classifying the information in detail in stages without affecting the target object when collecting information, and to automatically verify the validity of the collected threat information by performing tests on the collected security threat information with an automated function rather than a diagnostician (a human).

### BRIEF DESCRIPTION OF DRAWINGS

FIG. 1 is a conceptual diagram illustrating a cybersecurity management device according to an embodiment of the present invention.

FIG. 2 is a conceptual diagram illustrating an information collection operation of the security information collection unit according to an embodiment of the present invention.

FIG. 3 is a conceptual diagram illustrating the security threat test operation of the security threat test unit according to an embodiment of the present invention.

FIG. 4 is a conceptual diagram illustrating a method of managing a security threat in stages according to an embodiment of the present invention.

### DETAILED DESCRIPTIONS OF EXEMPLARY EMBODIMENTS

The detailed description of the present invention set forth below refers to the accompanying drawings which illustrate specific embodiments in which the present invention may be practiced. These embodiments are described in sufficient detail to enable those skilled in the art to practice the present invention. It should be understood that the various embodiments of the present invention, while different from each other, are not necessarily mutually exclusive. For example, specific shapes, structures, and characteristics described herein may be modified and implemented from one embodiment to another without departing from the spirit and scope of the present invention. It should also be understood that the positions or arrangements of individual components within each embodiment may be changed without departing from the spirit and scope of the present invention. Accordingly, the detailed description set forth below is not to be taken in a limiting sense, and the scope of the present invention is to be taken to encompass the scope of the claims and all equivalents thereof. Like reference numerals in the drawings represent the same or similar elements throughout several aspects.

Hereinafter, various exemplary embodiments of the present invention will be described in detail with reference to the attached drawings so that a person having ordinary skill in the art to which the present invention pertains can easily practice the present invention.

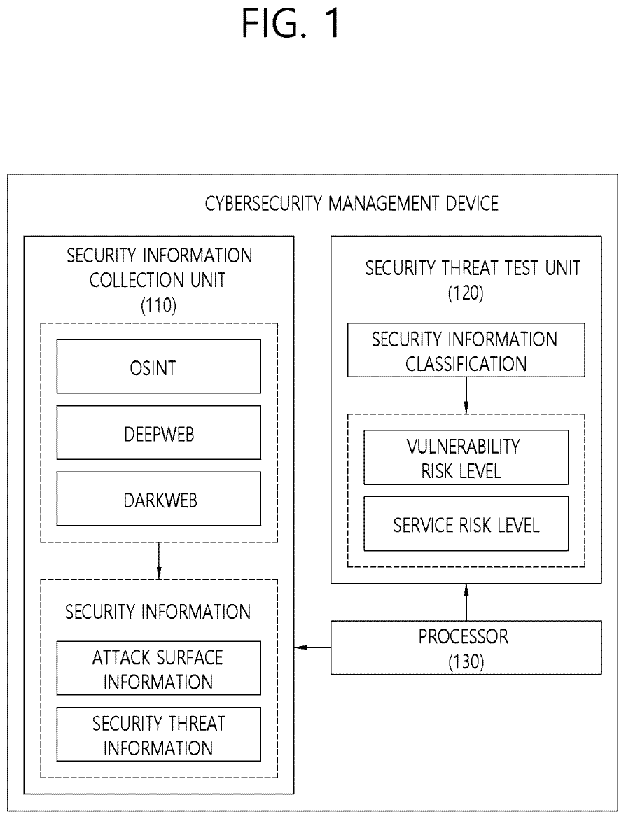

FIG. 1 is a conceptual diagram illustrating a cybersecurity management device according to an embodiment of the present invention.

In FIG. 1, a cybersecurity management device for detecting a security threat and performing automated security threat test for a security threat is disclosed.

Referring to FIG. 1, the cybersecurity management device may include a security information collection unit 110, a security threat test unit 120, and a processor 130.

The security information collection unit 110 may be implemented to collect attack surface information and security threat information that may constitute a security threat.

The attack surface information may include information on assets of a company, which include network equipment, a database (DBs), a server, a port, an application, and a domain and are connected to the Internet and exposed to risks. More broadly, personnel who manage corporate confidential information may also be included in the attack surface.

The security threat information may include information capable of threatening the security of the company, including information exposed through various types of webs and apps.

The security information collection unit 110 may collect security threat information and attack surface information from different paths, including OSINT (information collectable from general open_web/surface_web environments), DeepWeb (information collectable through login), and DarkWeb (information collectable by accessing a special path other than open/deepWeb).

The security information collection unit 110 may selectively collect various types of security threat information and attack expression information by dividing the information in detail in stages without affecting the target subject to the security threat when collecting attack surface information and security threat information.

For example, the security information collection unit 110 may collect security information in the following steps.
Step 1—collection) Port scan information collection: Performing port scan to identify services exposed to the outside.
Step 2—collection) Publicly available information collection: Collecting publicly available information (open source intelligence: OSINT) that may be accessible via the Internet (including information from Step 1).
Step 3—collection) Web crawling information collection: Collecting information from a website in service on the target assets, and then providing identified information leak items (including information from Step 1 and Step 2)
Step 4—collection) Vulnerability information collection of: Collecting known CVE (common vulnerabilities and exposures) (vulnerability DB information) mapping information based on identified services and collected asset information (including version information) (including information from Step 1/Step 2/Step 3)

By collecting security information set in the above-described steps, step-by-step security threat testing may be performed on the assets.

The security threat test unit 120 may be implemented to automatically verify the validity of the security threat information by performing an automated test based on the collected security threat information.

The security threat test unit 120 may perform a brute force (login brute-force) attack test by automatically logging into the exposed service and perform a known CVE (1-Day Exploit) test based on the exposed asset information, based on the collected security information.

When there is a known CVE (1-Day Exploit), the security threat test unit may perform a test using the corresponding exploit and then modify the exploit into a stabilized version for use as a testing module. Conversely, when there is no known CVE, the security threat test unit may easily generate an exploit directly through a CVE generation module in the cybersecurity management device, add the exploit as a module, and perform a test.

More specifically, the security threat test unit 120 may provide different types of security threat tests as follows.
Type 1) Automatically tests for the presence of vulnerability and provides results based on mapping information of asset information collected from an OSINT environment and confirmed CVE (vulnerability DB information)
Type 2) Automatically tests whether login is possible to a target system by collecting leaked dark web account (ID/PW) information, and provides evidence results
Type 3) Automatically performs a brute force attack test to see whether login is possible by checking externally exposed login pages (administrator pages) and provides evidence results

In addition, the security threat test unit 120 may classify the security information of the test results, calculate vulnerability risk levels and service risk levels based on the security information, and provide the calculated results to the user.

The processor 130 may control the operations of the security information collection unit 110 and the security threat test unit 120.

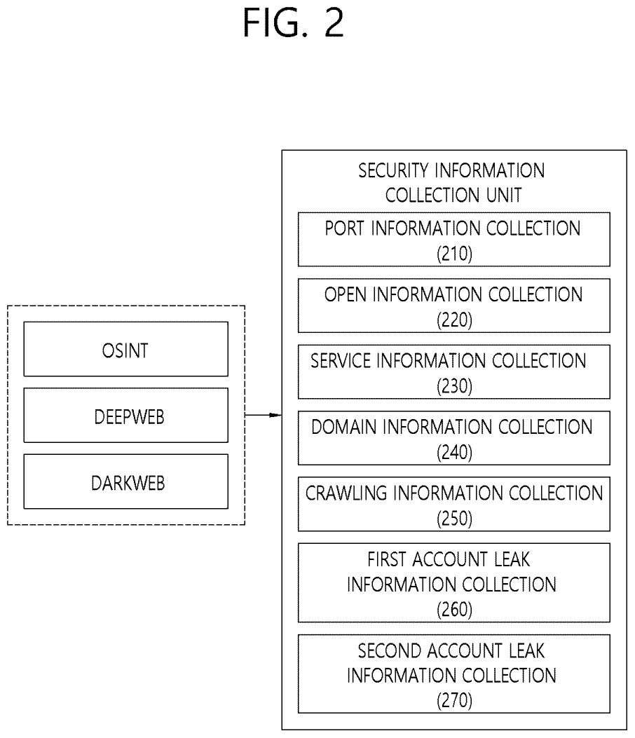

FIG. 2 is a conceptual diagram illustrating an information collection operation of the security information collection unit according to an embodiment of the present invention.

In FIG. 2, the security information collection operation of the security information collection unit is disclosed.

Referring to FIG. 2, as described above, the security information collection unit may collect security information on OSINT, deep web, and dark web.

Port information collection 210 may be performed through a combination of an Nmap (network mapper) function released as open source, a sentient hyper-optimized data access network (Shodan), and network information collection commands.

Open information collection 220 may be performed based on search results from search engines (e.g., Google, Bing, Edge, and various other browsers).

Service information collection 230 may be performed based on the collection of asset/version information from Request/Response information of a web service and the collection of information regarding whether a login page is present in the service.

Domain information collection 240 may be performed through web searches, a domain name system (DNS) search, Internet protocol (IP) verification, subdomain verification, and location verification.

Crawling information collection 250 may be performed by crawling login page information through implementing a function that automatically checks whether there is a login form in an externally opened service page through automatic source analysis and automatically checks whether there is a login page in the page.

First account leak information collection 260 may be performed through a function of searching a well-known dark web site and collecting personal credential leak information based on a target domain to be searched.

Second account leak information collection 270 may be performed through a function of collecting information through a response value after making a request using an application programming interface (API) of an external organization that has an exposed information database (DB) on the dark web.

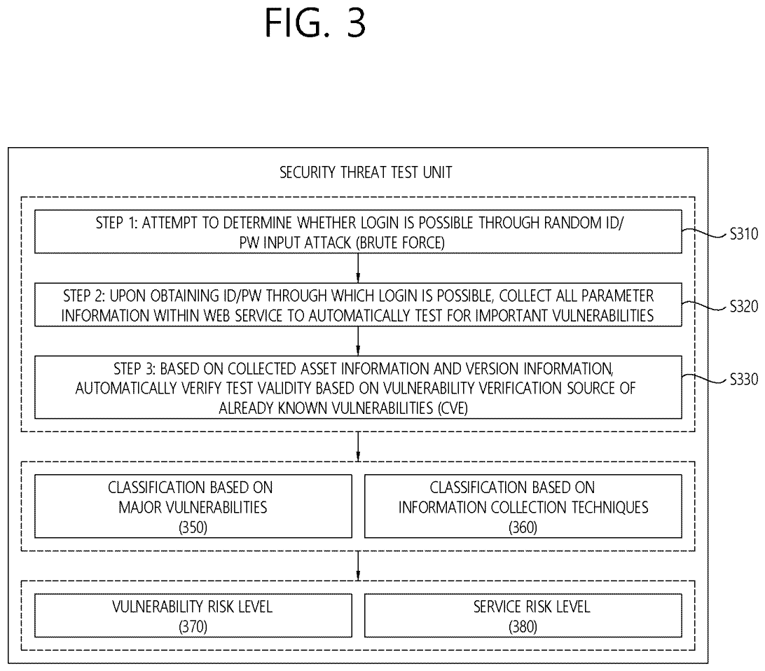

FIG. 3 is a conceptual diagram illustrating the security threat test operation of the security threat test unit according to an embodiment of the present invention.

In FIG. 3, an operation of the security threat test unit for performing a security threat test and providing a test result report is disclosed.

Referring to FIG. 3, the security threat test unit may perform a test for a security threat through the following operations.
Step 1: Attempt to determine whether login is possible through a random ID/PW input attack (Brute Force) (S310)
Step 2: Upon obtaining an ID/PW through which login is possible, collect all parameter information within the web service to check whether there is an information exposure page, a directory listing, or a vulnerable page, and automatically test for important vulnerabilities (authentication bypass, SQL injection, etc.) (S320)
Step 3: Based on the collected asset information and version information, automatically verify test validity (PoC: Proof of Concept) based on the Exploit (vulnerability verification source) of already known vulnerabilities (CVE) (S330)

The security threat test unit may perform tests on security threats through the above steps and determine the level of risk through the following procedures.

The classification of collected security information may target all information that a hacker needs to collect and analyze before initial infiltration.

The classification of security information may be performed by considering major vulnerabilities and/or information collection techniques. The following are classification based on major vulnerabilities 350 and/or classification based on information collection techniques 360.

### 1. Classification Based on Major Vulnerabilities 350

### 1) Broken Authentication

This is a vulnerability that occurs when there is weak control when accessing and modifying sensitive data or functions. When a page may be accessed or tampered with (modified, deleted) by an unauthorized user, the vulnerability is considered to be present. When authentication and session management are not properly implemented, an attacker may impersonate other uses or compromise keys and passwords.

### 2) Cryptographic Failures

Critical data such as financial records or health records need to be fully protected. Web applications do not properly protect personal information such as card numbers, leaving the personal information easily exposed to attackers. The exposed data may be used for various crimes.

### 3) Injection

Injection refers to an attack in which an attacker injects untrusted input values into a program. There are various types of injections, and one representative example is an SQL injection attack in which a query that is true or false is input as shown below and the database is manipulated.

### 4) Insecure Design

This is a security vulnerability that occurs due to implementation without threat modeling or insufficient design during the design phase of the secure software development lifecycle. For example, when malicious content is injected instead of normal content on a website bulletin board and executed, there are cases in which it is redirected to a malicious site.

### 5) Security Misconfiguration

This is an error that occurs due to erroneous/insufficient settings in all areas, including network services, platforms, and web servers. There are various situations for this vulnerability, and the vulnerability may be determined by checking system main information included in comments, exposure of error message information, and debug code that has not been removed but remains.

### 6) Vulnerable and Outdated Components

This is a security vulnerability occurring when components such as an OS, a web/application server, a database management system (DBMS), an application, an API, and all components, runtime environments, and libraries are outdated. For example, this may include cases in which a vulnerable version of SSL (SSL2.0/3.0, TLS1.0/1.1) among HTTPS protocols is applied, cases in which a weak encryption algorithm (DES, 3DES) is used, and cases in which a vulnerable version of a framework (Apache Struts 2) is used.

### 7) Identification and Authentication Failure

This is an item about security vulnerabilities related to user identification and authentication. For example, cases include when repetitive requests for user login are not controlled, when the existing session ID is fixed for login or the session ID is issued in a predictable pattern, when insecure ID unlocking or password retrieval logic is used, when default passwords such as password or admin, or weak or well-known passwords are identified, and the like.

### 8) Software and Data Integrity Failures

This involves integrity verification procedures, and the following are representative examples: no integrity verification conditions for serialized data, dependency on an untrusted library or source, the use of insecure CI/CD pipeline, and the like.

### 9) Security Logging and Monitoring Failures

This is due to insufficient logging and monitoring.

### 10 Server-Side Request Forgery

This may occur when a policy using HTTP headers to authorize a web application running on one origin to access resources on another origin (protocol, domain, port number) is not implemented or is misconfigured.

### 2. Classification Based on Information Collection Techniques 360

1) Active scanning: Information collection through IP block scanning, vulnerability scanning
2) Host information collection: Information collection on hardware, software, firmware, and client configuration
3) Identity information collection: Information collection on credentials, email addresses, and employee names
4) Network information collection: Information collection on domain properties, DNS, network trust dependencies, network topology, IP addresses, and network security appliances
5) Organizational information collection: Information collection on physical location and business relationships
6) Phishing for information: Spear phishing services, spear phishing attachments, and spear phishing links
7) Closed source search: Threat intelligence vendors, and purchasing of technical data
8) Open technical database search: DNS/passive DNS, WHOIS, digital certificates, CDN, database scans
9) Open website/domain search: Social media, search engines
10) Search of victim-owned websites

The risk of classified security information may be determined. The risk of security information may be determined based on a vulnerability risk level 370 and a service risk level 380.

The vulnerability risk level 370 based on security information may be determined based on the rating criteria of the CVE (common vulnerabilities and exposures) score.

The service risk level 380 based on security information may be determined as high/medium/low.
High: Assigned when at least one issue requiring an immediate solution is exposed. In other words, when an issue that may be used for hacking if not immediately solved is identified.
Medium: Assigned when there is a large amount of information that is not a current issue but may be used for hacking (open port information, dangerous port information, a plurality of web vulnerabilities, and the like), and action is required.
Low: Assigned when it is difficult to use the exposed information for direct hacking attacks, but there is a risk of performing an attack when combined with social engineering techniques (phishing emails, and the like) or other information.

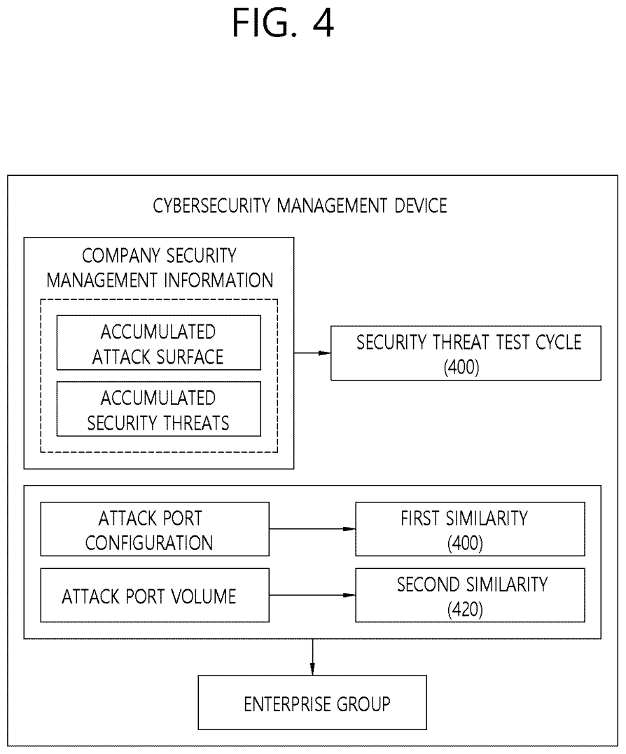

FIG. 4 is a conceptual diagram illustrating a method of managing a security threat in stages according to an embodiment of the present invention.

In FIG. 4, a method of managing a security threat in stages based on attack surface information and security threat information is disclosed.

Referring to FIG. 4, a cybersecurity management device may define levels of attack surface information and security threat information based on collection of security threat information and test results for security threats and manage the information at different grading for each company.

Security threat information, service risk levels based on security threat information, and information about collected attack ports may be tagged to generate company security management information for a company. For example, information on the source of the attack surface from which security threat information is acquired may be tagged together such as (security threat information 1, high, a first server), (security threat information 2, medium, a third port), (security threat information 3, medium, a domain) to generate company security management information.

When company security management information is accumulated, data on attack surfaces that frequently cause issues and security threat information that frequently causes issues may be accumulated. A security threat test cycle 400 may be set differently based on the accumulated attack surfaces and the accumulated security threats that accumulates the security management information of the company.

An accumulated attack surface with a higher occurrence rate among the accumulated attack surfaces may be assigned a shorter security threat test cycle 400 based on the attack surface, and an accumulated attack surface having allowed access of security threat information that causes a high service risk level among the accumulated attack surfaces may be assigned a shorter security threat test cycle 400. In addition, an accumulated attack surface that continuously changes (e.g., increasing numbers of ports or server) compared to the fixed attack surface among the accumulated attack surfaces may be assigned a shorter security threat test cycle 400.

Depending on the setting of the security threat test cycle 400, scanning for different attack surfaces and a security threat testing cycle for security threat information acquired from the attack surface may be performed at different cycles. The security threat test cycle may be set in various time units (minutes, hours, days, weeks, or months). Depending on the characteristics of the security threat information acquired from the attack surface (e.g., whether it is continuously generated information (e.g., ID/PW)), the security threat test cycle may be set differently in various time units.

In addition, according to an embodiment of the present invention, a method of adaptively performing a different security threat test for each company based on information about attack surfaces when each company may have a different attack surface is disclosed.

Depending on the characteristics of the company, the configuration of the attack port and the volume of the attack port may vary. In the present invention, initial security threat test setting may be performed for each company by considering the similarity of the attack port configuration.

Based on information about the configuration of the attack port, such as network equipment and databases (DB), servers, ports, applications, and domains for each company, a first similarity 410 for the attack port configuration for each company may be determined.

More specifically, the configuration of attack ports such as servers, ports, applications, and domains may be simulated and expressed by considering the interrelationships in the network space, and based on the relationship information between the servers, ports, applications, and domains, the first similarity 410 for the attack port configuration for each company may be determined.

In addition, a second similarity for the attack port volume for each company may be determined based on the volume of the attack port for each company.

The cybersecurity management device may select a first similar candidate company based on the first similarity 410 and select the final similar company based on the second similarity 420. The first similar candidate company and the final similar company may be companies that have previously performed security threat tests more than a threshold number of times.

As described above, the final similar companies and new companies may form a single company group, and the security threat test may be performed on the company group. The cybersecurity management device may set the same security threat test cycle for the company performing the initial security threat test as the final similar company and perform the security threat test.

Depending on the change in the attack surface of a company and the change in the volume of the attack surface, a company group in which companies are included may change, and accordingly, the cycle of security threat testing for the attack surface may change. In addition, the results of security threat tests of companies included in the company group may be applied to the entire company group, and the rules for security threat testing of the company group itself may change. Through this method, by considering security threats that have occurred in other companies, companies with similar characteristics may rapidly and accurately screen for the presence of security threats through security threat tests in advance.

Although the present invention has been described above with reference to specific details such as specific components and limited examples and drawings, these have been provided only to provide a more general understanding of the present invention, the present invention is not limited to the above examples, and those with common knowledge in the technical field to which the present invention pertains may make various modifications and changes based on this description.

Therefore, the idea of the present invention should not be limited to the embodiments described above, and not only the scope of the patent claims described below but also all scopes equivalent to or equivalently modified from the scope of the patent claims are included in the scope of the idea of the present invention.

1. A method of managing cybersecurity a threat and an attack surface, comprising:
collecting, by a cybersecurity management apparatus, attack surface information and security threat information; and
automatically verifying, by the cybersecurity management apparatus, validity of the security threat information by performing an automated test based on the attack surface information and the security threat information.

2. The method of claim 1, wherein the attack surface information includes information on assets of a company, which include network equipment, a database (DB), a server, a port, an application, and a domain and are connected to the Internet and exposed to risks, and
the security threat information includes information exposed through a web or an application that threatens security of the company.

3. The method of claim 2, wherein the cybersecurity management apparatus collects the security threat information and the attack surface information through open source intelligence (OSINT) including general Open_web and Surface_web, DeepWeb, and Dark Web.

4. A cybersecurity management device for managing a cybersecurity threat and an attack surface, the cybersecurity management device configured to:
collect attack surface information and security threat information; and
automatically verify validity of the security threat information by performing an automated test based on the attack surface information and the security threat information.

5. The cybersecurity management device of claim 4, wherein the attack surface information includes information on assets of a company, which include network equipment, a database (DB), a server, a port, an application, and a domain and are connected to the Internet and exposed to risks, and
the security threat information includes information exposed through a web or an application that threatens security of the company.

6. The cybersecurity management device of claim 5, wherein the cybersecurity management apparatus collects the security threat information and the attack surface information through open source intelligence (OSINT) including general Open_web and Surface_web, DeepWeb, and Dark Web.
